(19) United States
(12) Patent Application Publication
(10) Pub. No.: US 2014/0367321 A1
(43) Pub. Date: Dec. 18, 2014

(54) QUICK CHANGE KEYED WATER FILTER ASSEMBLY

(71) Applicant: Maxtec Plastics, Inc., Taichung City (TW)

(72) Inventor: Shih-Ping LEE, Taichung City (TW)

(21) Appl. No.: 13/920,595

(22) Filed: Jun. 18, 2013

(51) Int. Cl. B01D 35/30

(52) U.S. Cl. CPC B01D 35/306
USPC 210/232

(57) ABSTRACT

A water filter assembly has a filter head and a filter. The filter head has an outer casing, a filter connector, two key tabs and two tab fasteners. The filter connector and the key tabs are securely mounted in the outer casing by the tab fasteners. The keyed tabs are mounted respectively in two tab holes in the connecting bracket, and each keyed tab has a key block formed on the inner surface of the keyed tab. The filter is connected detachably with the filter head and has a filter body, a keyed collar and a collar fastener. The keyed collar is mounted around the top end of the filter body by the collar fastener and has a key block detachably engaging the key blocks on the keyed tabs.

### BACKGROUND OF THE INVENTION

1. Field of the Invention

The present invention relates to a water filter assembly, and more particularly to a quick change keyed water filter assembly.

2. Description of Related Art

A conventional water filter assembly is mounted on a water system to filter water before providing to a user and substantially comprises a filter head and a filter. To fit different filtering purposes, the conventional water filer assembly is provided with different filtering cartridges in a filter vessel. To prevent a filter having a different filtering cartridge is assembled onto a filter head for a specific filtering purpose, a key is formed on a filter body of the filter to fit with a corresponding key formed on the filter head. Thus, only a specific filter can be assembled on a specific filter head to achieve a specific filtering purpose, such that a fool-proofing effect is provided.

However, the conventional key is integrally formed on the filter body of the filter, so multiple molds for forming keys in different shapes on filter bodies and the filter head have to be prepared during the manufacturing process of the conventional water filter assemblies. Therefore, the process for manufacturing the conventional water filter assembly is costly.

In addition, the filter body of the water filter assembly is an elongate container for receiving a filter core, and the key is usually formed near a top end of the filter body. The conventional filter body is usually formed with an injection molding process with a mold. However, to be limited by the technique of the injection molding process and the shape of the mold, the key formed on the conventional filter body has a limited form, shape and arrangement. For example, the conventional key cannot be formed as a non-spiral form on the filter body, or if the conventional key has multiple openings or dents, the openings or dents have to be formed in a top edge of the conventional key. Therefore, the forms, shapes and arrangements of the conventional keys on the filter body are limited and are not versatile in designs.

To overcome the shortcomings, the present invention tends to provide a quick change keyed water filter assembly to mitigate or obviate the aforementioned problems.

### SUMMARY OF THE INVENTION

The main objective of the invention is to provide a quick change keyed water filter assembly that is easily manufactured in reduced costs and is versatile in use.

The water filter assembly has a filter head and a filter. The filter head has an outer casing, a filter connector, two key tabs and two tab fasteners. The outer casing has an inner surface and two securing recesses defined in the inner surface of the outer casing. The filter connector is tubular, is mounted in the outer casing and has an outer surface and two tab holes defined through the outer surface of the filter connector and aligning respectively with the securing recesses in the outer casing. The keyed tabs are mounted respectively in the tab holes in the connecting bracket, and each keyed tab has an inner surface and a key block formed on the inner surface of the keyed tab. The tab fasteners are mounted respectively in and protrude partially out of the tab holes and extend respectively into the securing recesses to securely hold the filter connector in the outer casing. The filter is connected detachably with the filter head and has a filter body, a keyed collar and a collar fastener. The filter body has a top end extending detachably into the filter connector and a combining recess. The combining recess is annular and is defined around the filter body at a position near the top end. The keyed collar is mounted around the top end of the filter body, is detachably engaging the keyed tabs and has an inner surface, an outer surface and a key block formed on the outer surface of the keyed collar and detachably engaging the key blocks on the keyed tabs. The collar fastener is mounted in and protrudes partially out of the combining recess and abuts the inner surface of the keyed collar to securely hold the keyed collar on the filter body.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a water filter assembly in accordance with the present invention;

FIG. 2 is an exploded perspective view of the water filter assembly in FIG. 1;

FIG. 3 is an enlarged front view in partial section of the water filter assembly in FIG. 1;

FIG. 4 is an enlarged exploded perspective view of the filter of the water filter assembly in FIG. 1;

FIG. 5 is an enlarged front view in partial section of the filter of the water filter assembly in FIG. 1;

FIGS. 6A to 6D show operational side views and top views in partial section of the process of assembling the keyed collar with the filter body by the collar fastener of the water filter assembly in FIG. 1;

FIGS. 7A to 7L show exploded perspective views of the keyed tabs and the keyed collar with different embodiments of key blocks in accordance with the present invention;

FIG. 8 is an operational side view showing the engagement between the keyed tab and the keyed collar having key blocks in corresponding form, shape and arrangement;

FIG. 9 is a side view showing that the keyed tab and the keyed collar having key blocks not in corresponding form, shape and arrangement cannot engage with each other;

FIGS. 10A to 10F show perspective views of embodiments of filter connectors in accordance with the present invention;

FIGS. 11A and 11G show perspective views of embodiments of outer casings in accordance with the present invention;

FIG. 12 is an operational perspective view of two water filter assemblies in accordance with the present invention applied to a manifold bracket;

FIG. 13 is a partially exploded perspective view of the outer casings of the water filter assemblies with a supporting bracket of the manifold bracket in FIG. 13;

FIG. 14 is an operational perspective view of three water filter assemblies in accordance with the present invention applied to a manifold bracket;

FIG. 15 is a front view in partial section of the water filter assemblies in FIG. 14;

FIG. 16 is a partially exploded perspective view of an operational embodiment of a water filter assembly in accordance with the present invention;

FIG. 17 is an enlarged front view in partial section of the water filter assembly in FIG. 16; and

FIG. 18 is a side view in partial section of an alternative embodiment of a water filter assembly in accordance with the present invention.

### DETAILED DESCRIPTION OF PREFERRED EMBODIMENT

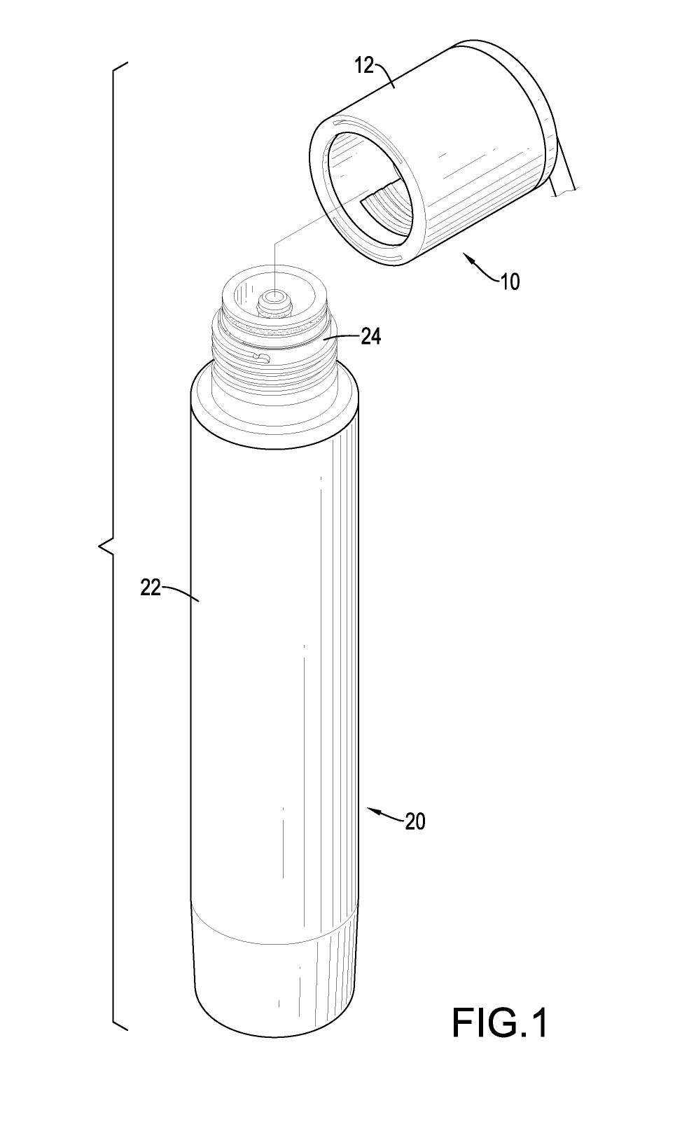

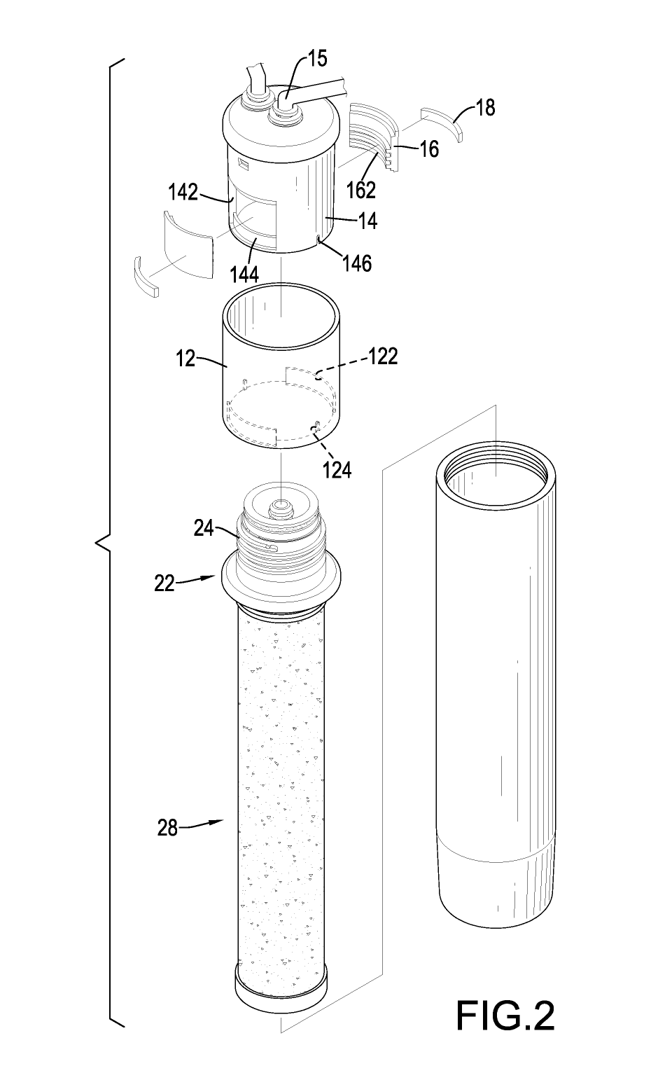

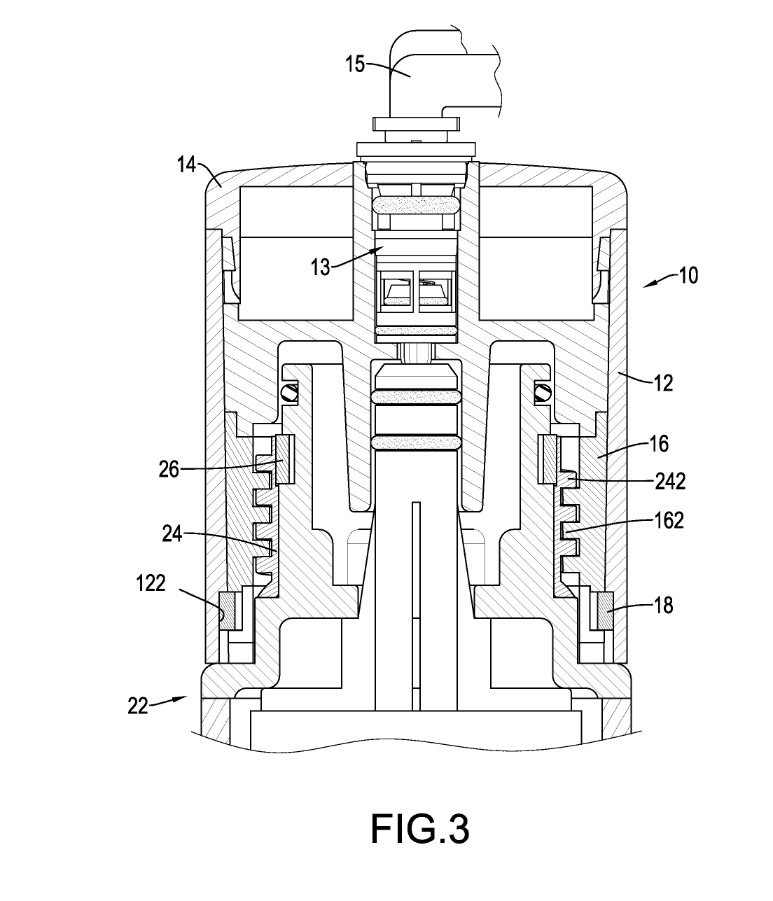

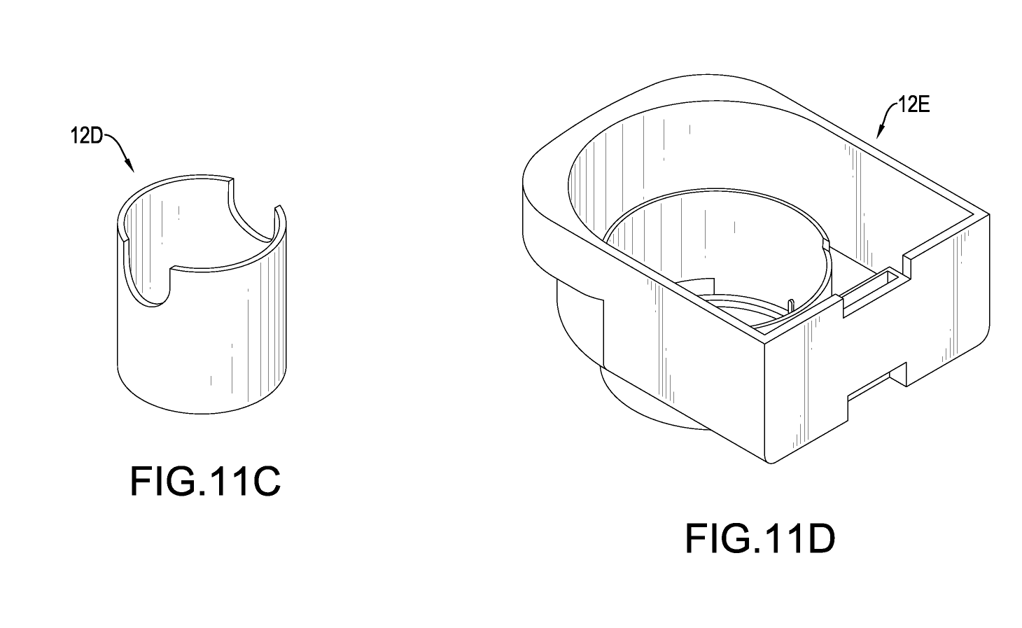

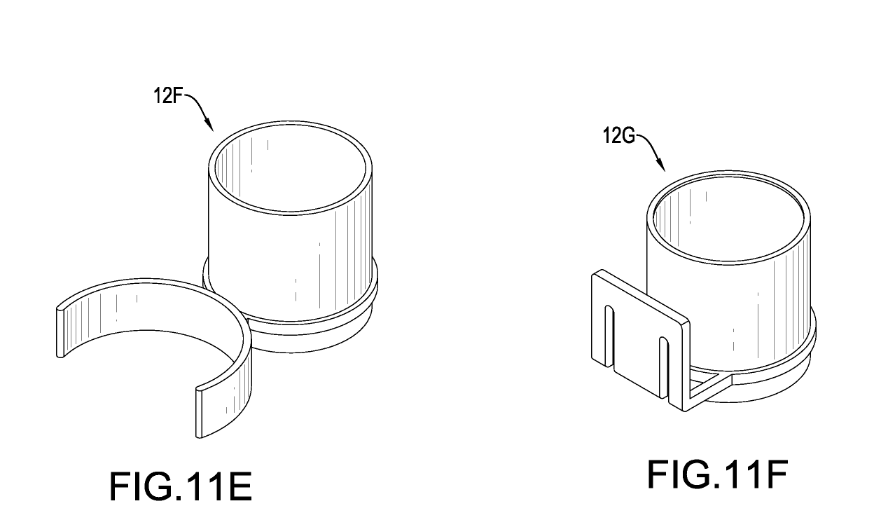

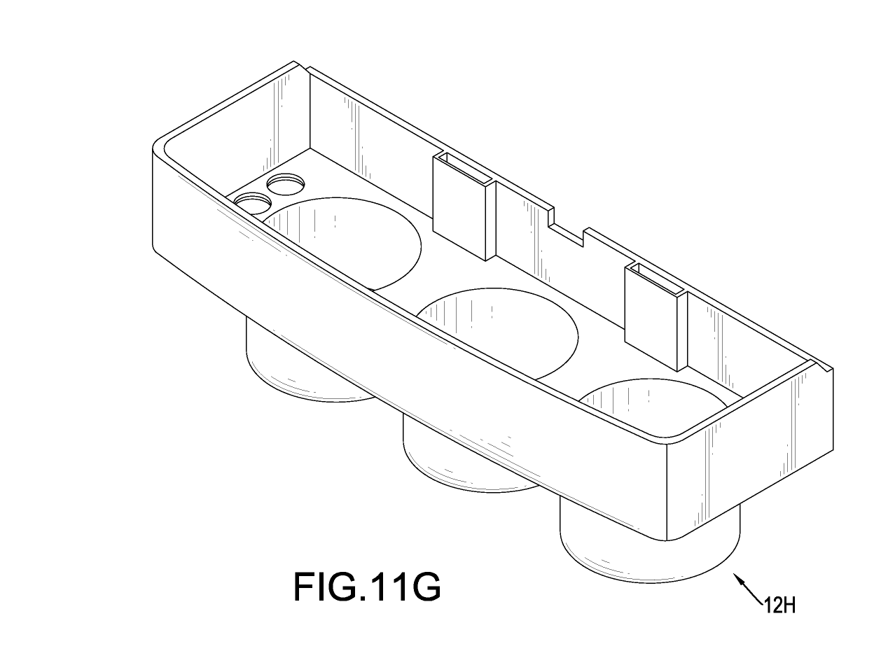

With reference to FIGS. 1 and 2, a quick change keyed water filter assembly in accordance with the present invention comprises a filter head 10 and a filter 20. The filter head 10 has a water flow passage formed inside the filter head 10 and comprises an outer casing 12, a filter connector 14, two keyed tabs 16 and two tab fasteners 18. A check valve 13 may be mounted in the filter head 10 to control the water flow in the water flow passage as shown in FIG. 3. The outer casing 12 is hollow, may be tubular, can be securely connected to or mounted on an object to attach the water filter assembly to the object. To attach the outer casing 12 to an object, a securing frame as shown in FIG. 11F or a C-shaped holding ring as shown in FIG. 11E is mounted on the outer casing 12F,12G. The outer casing 12 comprises an inner surface and two securing recesses 122. The securing recesses 122 are defined in the inner surface near the bottom end of the outer casing 12. Preferably, the securing recesses 122 are defined respectively in two ends of a diameter of the outer casing 12, and two ends of the outer casing are opened. In addition, with reference to 11A, two ears are formed on and protrude from the top end of the outer casing 12A. In another embodiment as shown in FIGS. 11B and 11D, a connecting frame is formed on the outer casing 12B,12E. With the ears or the connecting frame, the outer casing 12A, 12B,12E can be securely connected with or mounted on a specific object.

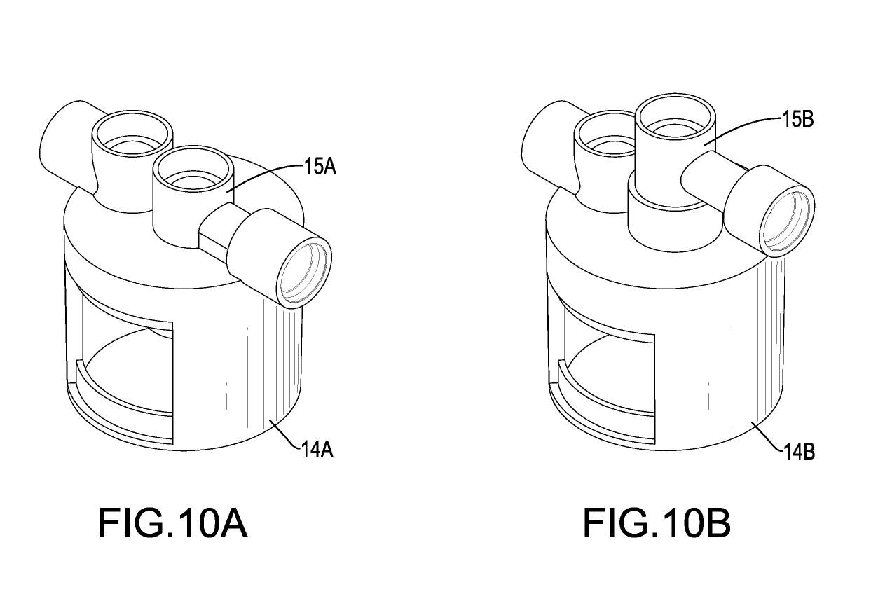

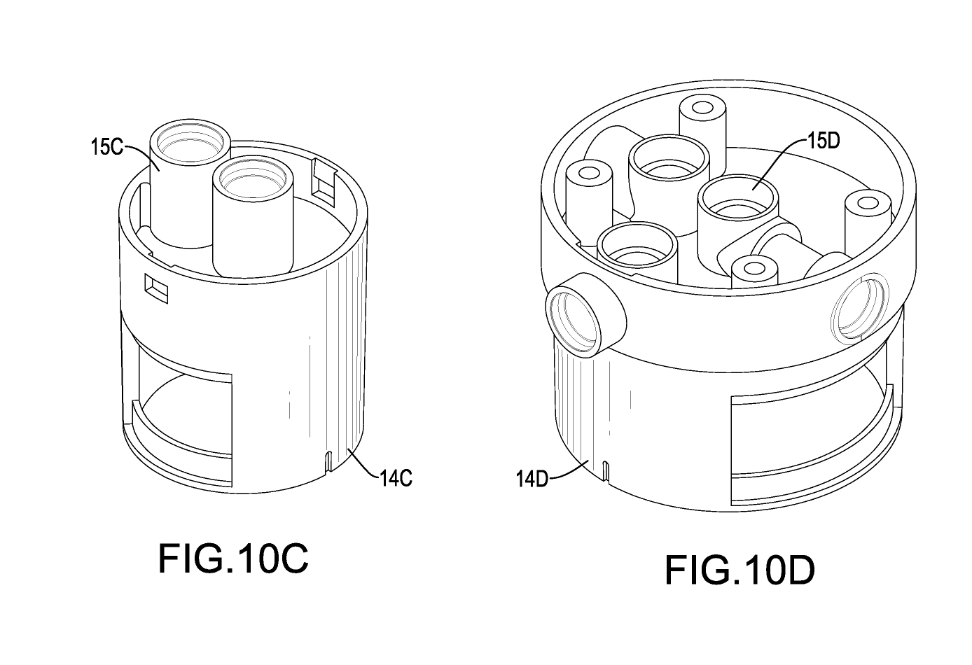

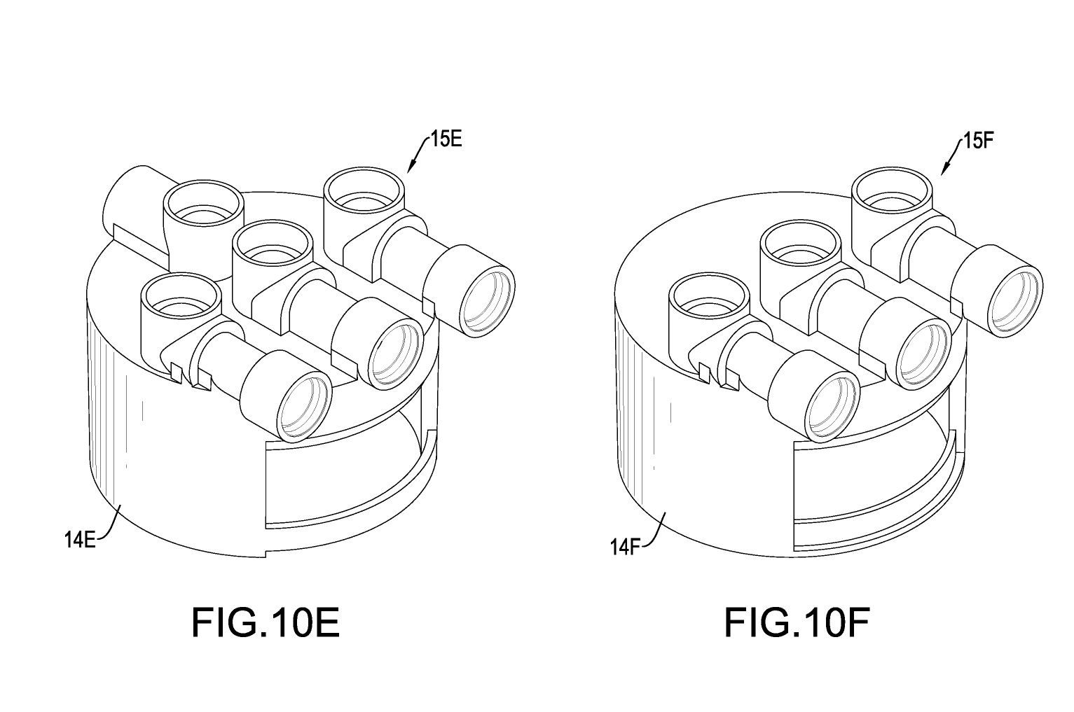

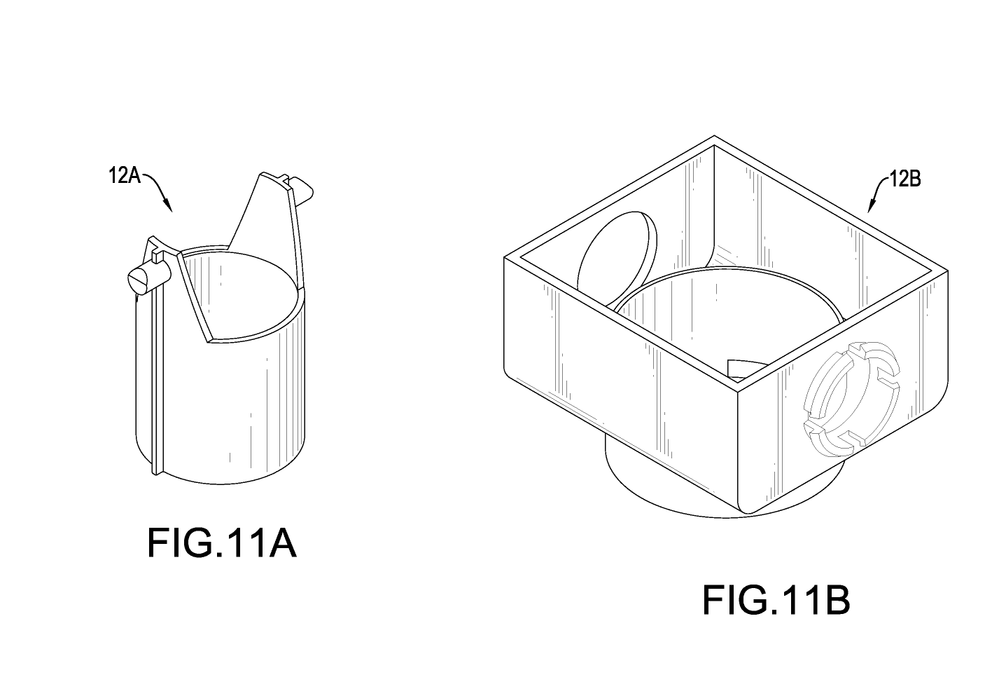

With reference to FIG. 11C, two recesses are defined in the top end of the outer casing 12D for different mounting purpose. Furthermore, with reference to FIG. 11G, multiple outer casings 12H are integrally connected with a frame to form a manifold bracket. The filter connector 14 is tubular, is mounted in the outer casing 12 and has a top, a bottom, an outer surface and two tab holes 142. The water flow passage is formed in and the check valve is mounted in the filter connector 14. The top of the filter connector 14 may be closed, and at least one hose connector 15 is mounted on the top of the filter connector 14 and communicates with the water flow passage. With reference to FIGS. 10A to 10F, multiple hose connectors 15A to 15F are formed on the top of the filter connectors 14A to 14F to fit with different connection purposes. The bottom of the filter connector 14 may be opened. The tab holes 142 are defined through the outer surface of the filter connector 14 and align respectively with the securing recesses 122 in the outer casing 12. Preferably, each tab hole 142 is a stepped hole and includes a large segment and a through segment. The large segment is defined in and free from through the outer surface of the filter connector 14 and has a bottom. The through segment is defined through the bottom of the large segment, so that an abutting shoulder 144 is formed on the bottom of the large segment.

The keyed tabs 16 are mounted respectively in the tab holes 142 in the connecting bracket 14, and each keyed tab 16 has an inner surface and a key block 162 formed on the inner surface of the keyed tab 16. Preferably, each keyed tab 16 has an area smaller than that of the large segment of the corresponding tab hole 142 and larger than that of the through segment of the corresponding tab hole 142. Accordingly, the keyed tabs 16 respectively abut the abutting shoulders 144 in the tab holes 142 and are kept from entering into the filter connector 14.

The tab fasteners 18 are mounted respectively in and protrude partially out of the tab holes 142 and extend respectively into the securing recesses 122 to securely hold the filter connector 14 in the outer casing 12. Preferably, each tab fastener 18 is curved and has a curvature different from that of the corresponding tab hole 142.

To combine the filter connector 14 with the keyed tabs 16 into the outer casing 12 by the tab fasteners 18, the keyed tabs 16 and the tab fasteners 18 are put respectively into the tab holes 142 in the filter connector 14 firstly. Then, the tab fasteners 18 are compressed to enter into the tab holes 142 entirely. The filter connector 14 with the keyed tabs 16 and the tab fasteners 18 is inserted into the outer casing 12 from an end of the outer casing 12. When the tab fasteners 18 align respectively with the securing recesses 122 in the outer casing 12, the tab fasteners 18 will expand and partially protrude out of the tab holes 142 and extend into the securing recesses 122 with the resilience of the tab fasteners 18. Accordingly, the tab fasteners 18 engage the securing recesses 122 to securely hold the filter connector 14 inside the outer casing 12 and to keep the filter connector 14 from rotating relative to the outer casing 12.

In addition, at least one positioning rib 124 and at least one positioning recess 146 are respectively formed on the inner surface of the outer casing 12 and the filter connector 14 and engage each other respectively. With the engagement between the at least one positioning rib 124 and at least one positioning recess 146, a positioning effect is provided and the filter connector 14 can be kept from rotating relative to the outer casing 12.

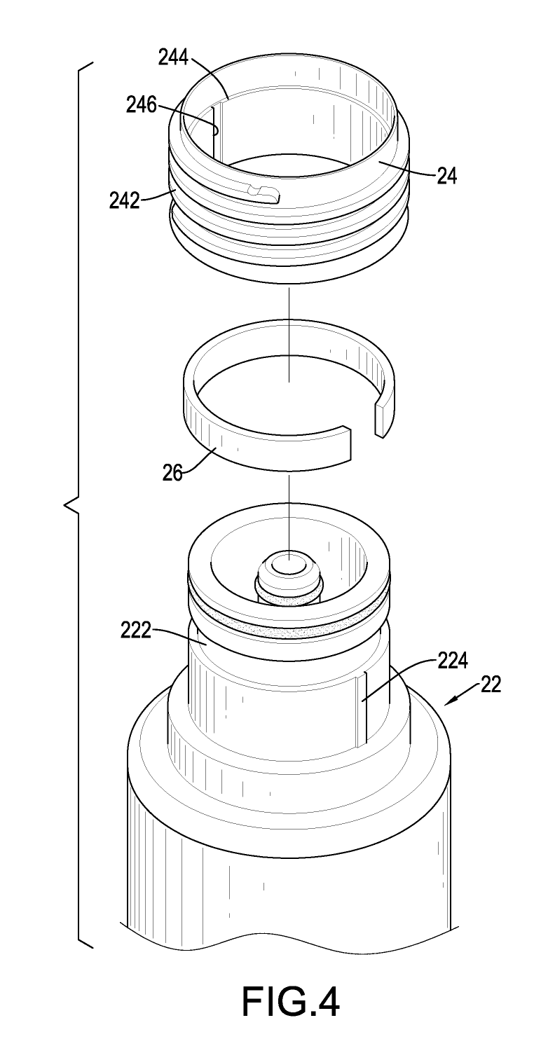

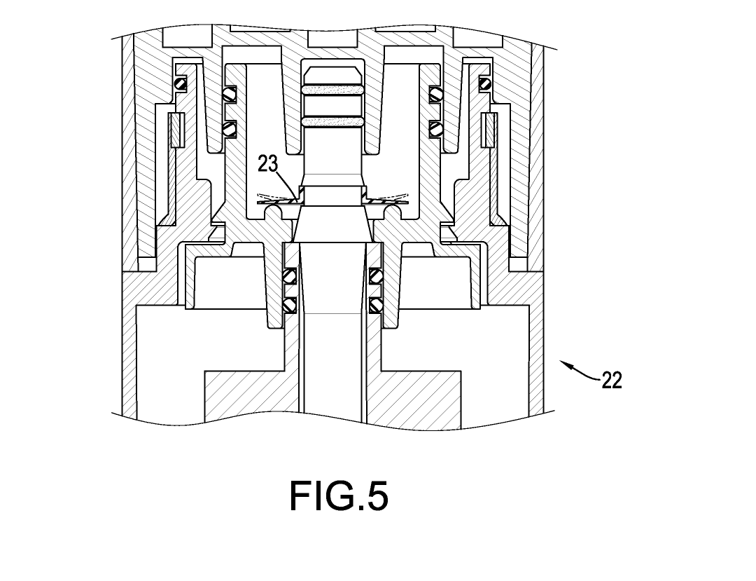

With reference to FIGS. 1, 2 and 4, the filter 20 is connected detachably with the filter head 10, has a water flow passage formed in the filter 20 and comprises a filter body 22, a filter cartridge 28, a keyed collar 24 and collar fastener 26. The filter body 22 has a top end and a combining recess 222, and the water flow passage is formed in the filter body 22. Preferably, the filter body 22 may comprise a connecting head and a vessel. The connecting head is securely combined with the vessel by threads or high frequency welding process. The filter cartridge 28 provides a specific filtering effect. With reference to FIGS. 5, 15 and 18, a rubber valve disk 23 is mounted in the filter body 22 to control the water flow in the waster flow passage in the filter body 22. The top end of the filter body 22 extends detachably into the filter connector 14. The combining recess 222 is annular and is defined around the filter body 22 at a position near the top end.

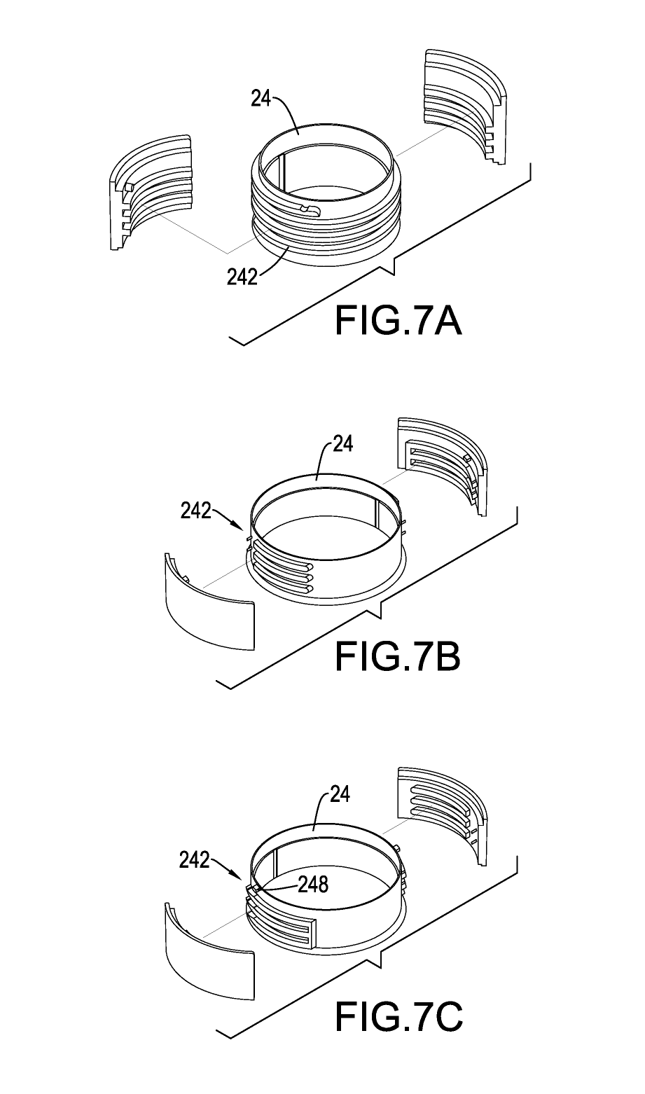

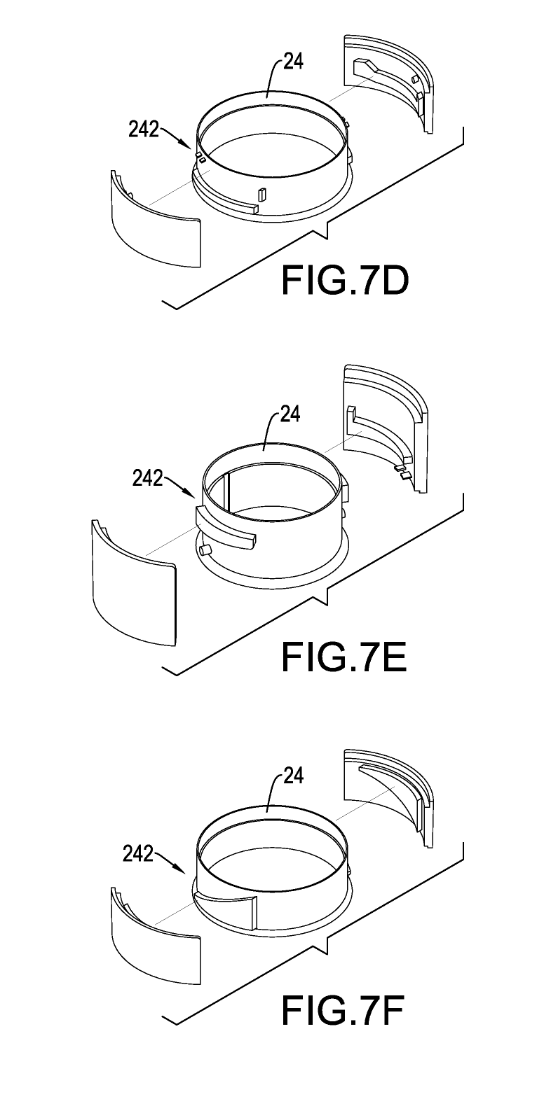

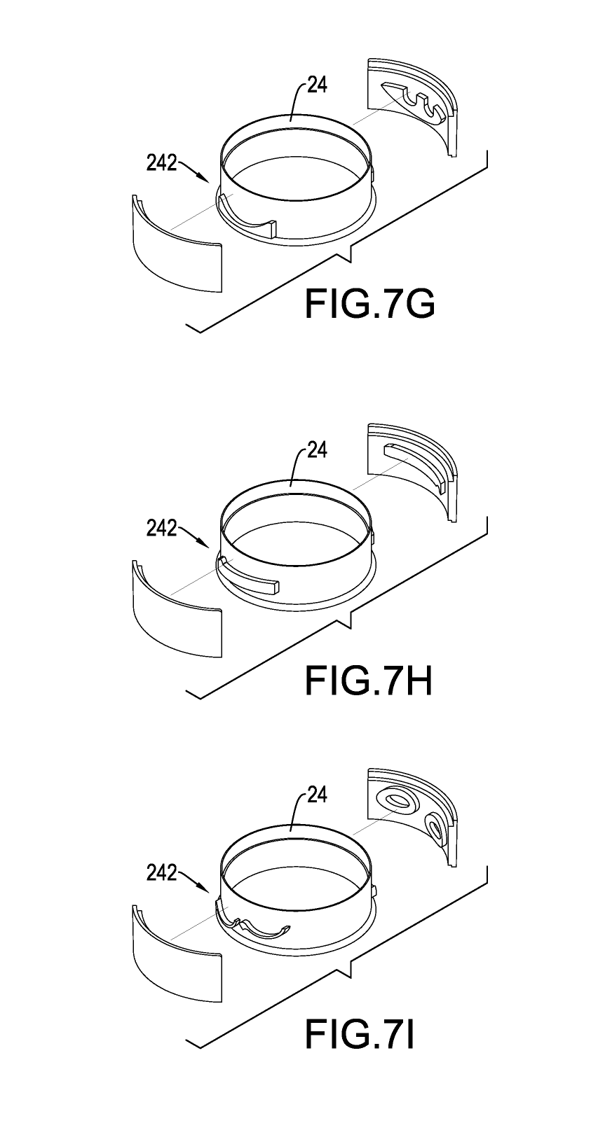

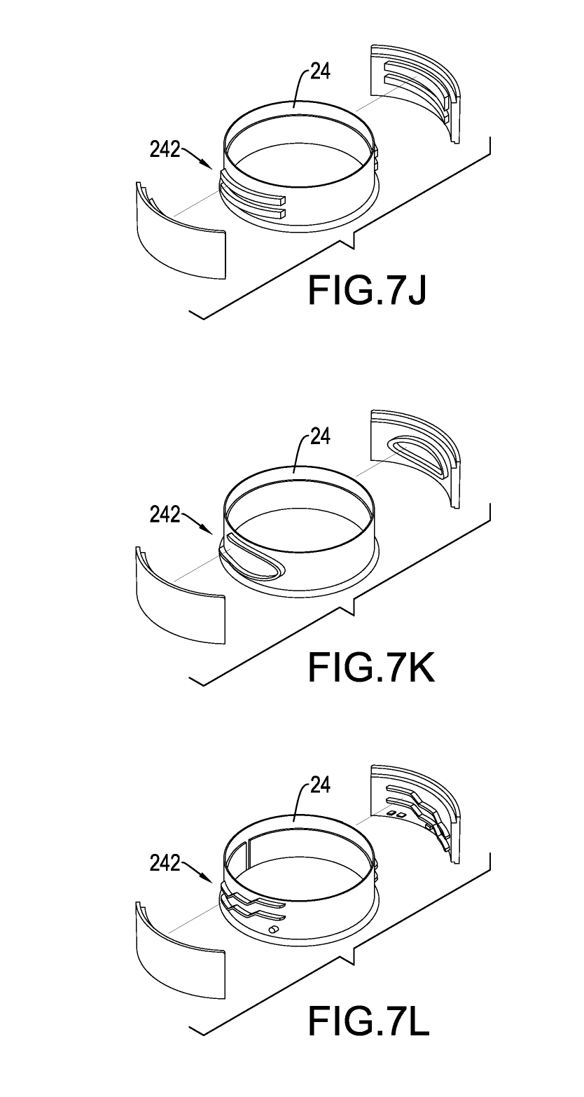

The keyed collar 24 is mounted around the top end of the filter body 22, is detachably engaging the keyed tabs 16 and has an inner surface, an outer surface and a key block 242. The key block 242 is formed on the outer surface of the keyed collar 24 and detachably engages the key blocks 162 on the keyed tabs 16. The key block 242 on the keyed collar 24 has a form, shape and arrangement corresponding to that of the key blocks 162 on the key tabs 16. In practice, the keyed collar 24 may comprise two segments that are respectively formed on two ends of a diameter of the keyed collar 24, and each segment may comprise a spiral, circular or annular rib, an elongated block with at least one notch or cutout formed in a top edge or a bottom edge of the block or multiple parallel, bent or stepped ribs as shown in FIGS. 7A to 7L. In addition, an enlarged hole is defined in an end of the keyed collar 24 to form an annular abutting shoulder 244 inside the keyed collar 24.

The collar fastener 26 is mounted in and protruding partially out of the combining recess 222 and abuts the inner surface, preferably the abutting shoulder 244, of the keyed collar 24 to securely hold the keyed collar 24 on the filter body 22. Preferably, the collar fastener 26 is C-shaped and has a curvature different from that of the combining recess 222. In addition, the filter body 22 is made of a material different from that of the keyed collar 24.

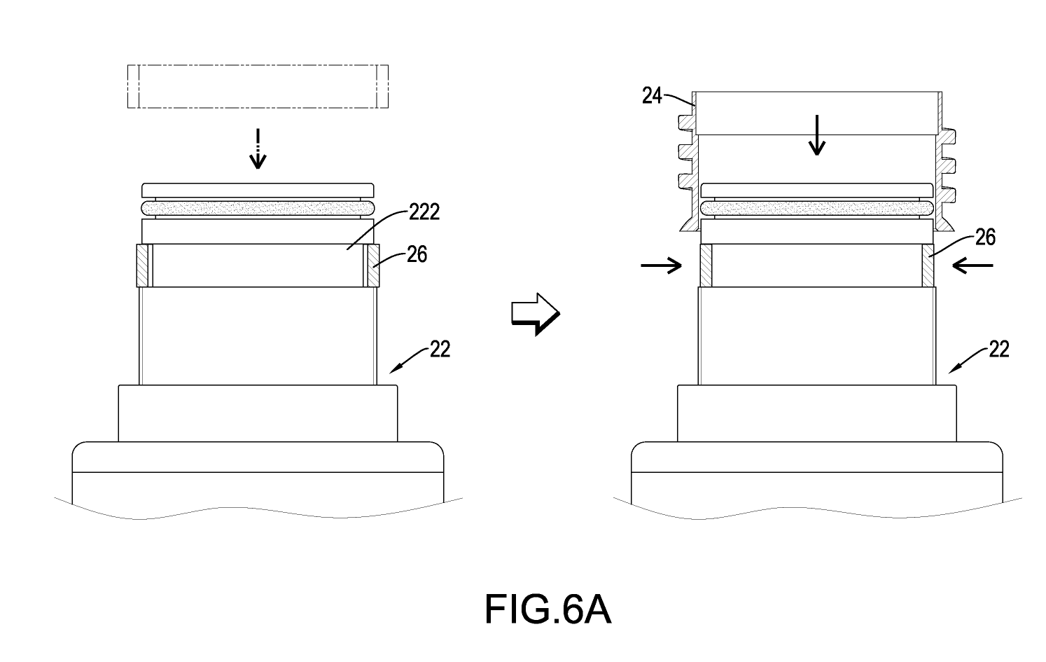

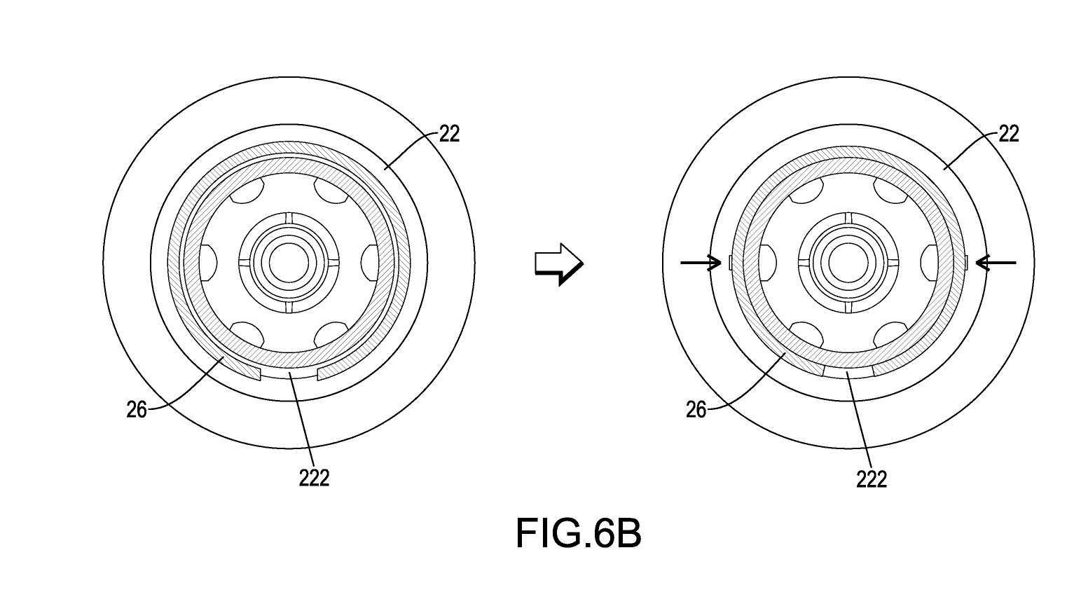

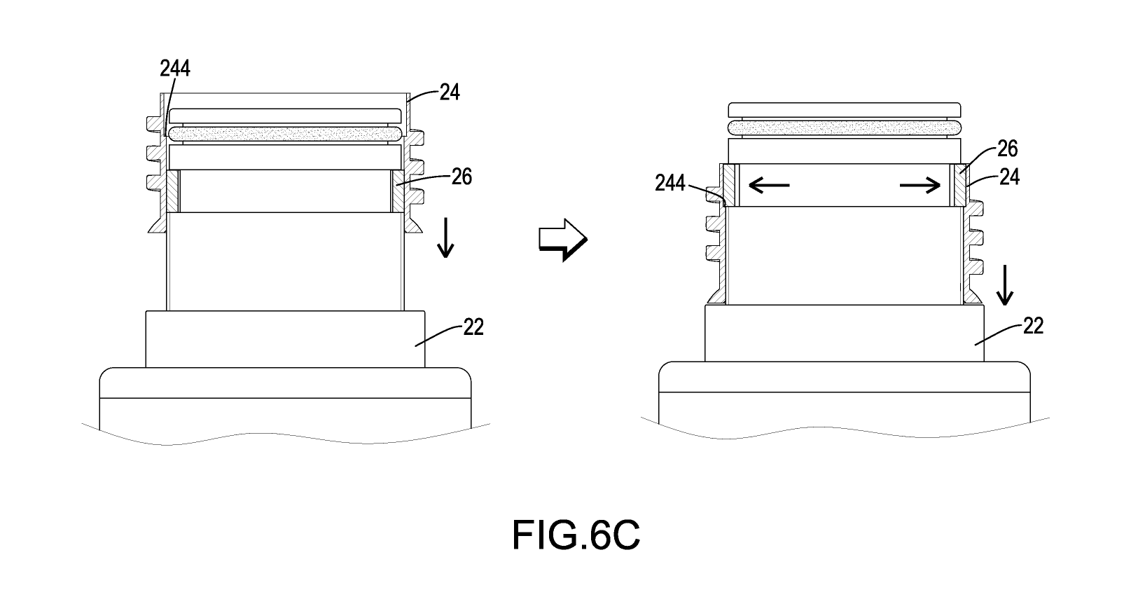

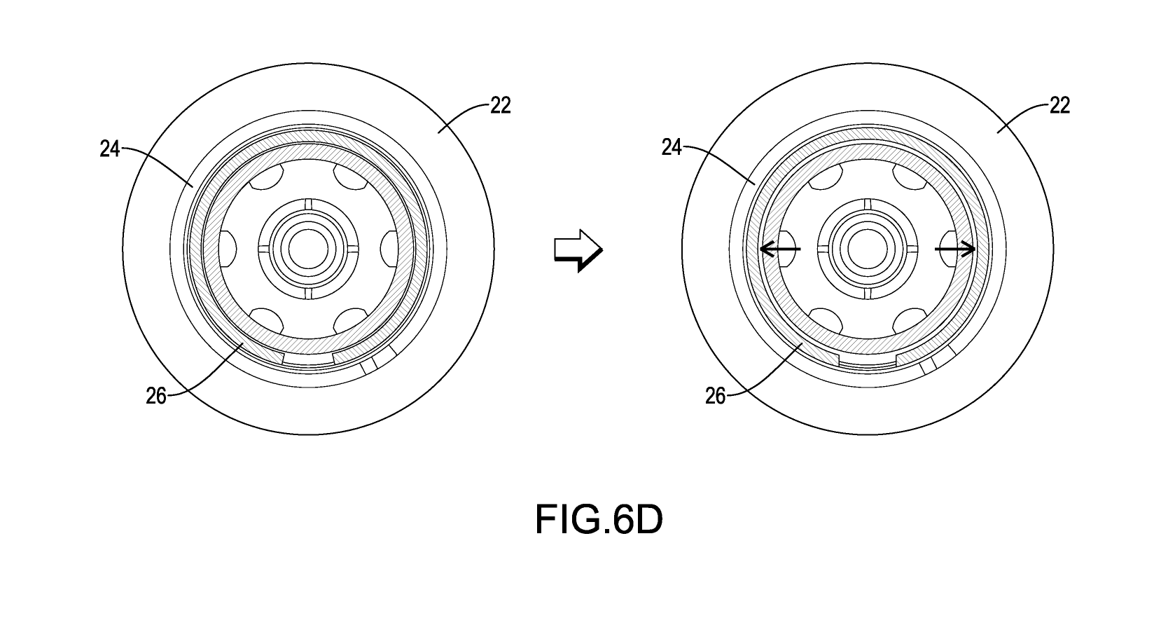

To combine the keyed collar 24 with the filter body 22 with the collar fastener 26, with reference to FIGS. 6A to 6D, the collar fastener 26 is put into the combining recess 222 in the filter body 22 firstly. Then, the collar fastener 26 is compressed to enter into the combining recess 222 entirely, and the top end of the filter body 22 is inserted into the keyed collar 24. When the collar fastener 26 aligns with the abutting shoulder 244 in the keyed collar 24, the tab fastener 26 will expand and partially protrude out of the combining recess 222 with the resilience of the collar fastener 26, extend into the enlarged hole and abut the abutting shoulder 244. Accordingly, the keyed collar 24 is attached onto and kept from detached from the top end of the filter body 22. In addition, a key 224 and a keyway 246 are respectively formed on the filter body 22 and the inner surface of the keyed collar 24 and engage each other. With the engagement between the key 224 and keyway 246, the keyed collar 24 can be kept from rotating relative to the filter body 22.

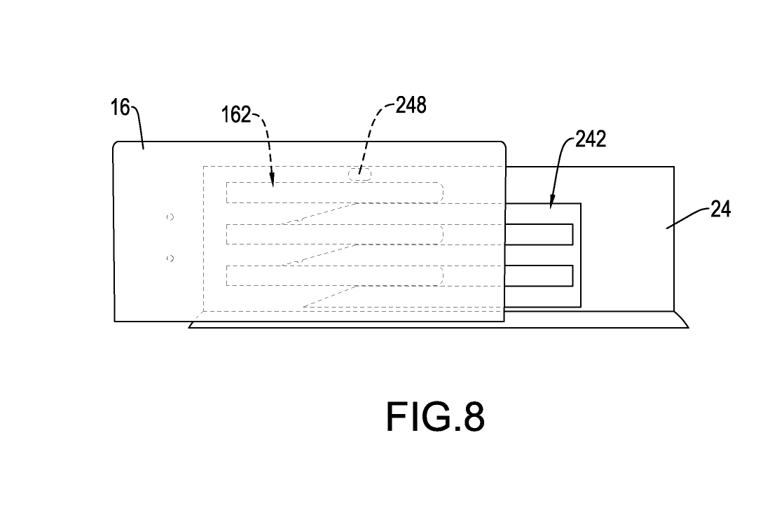

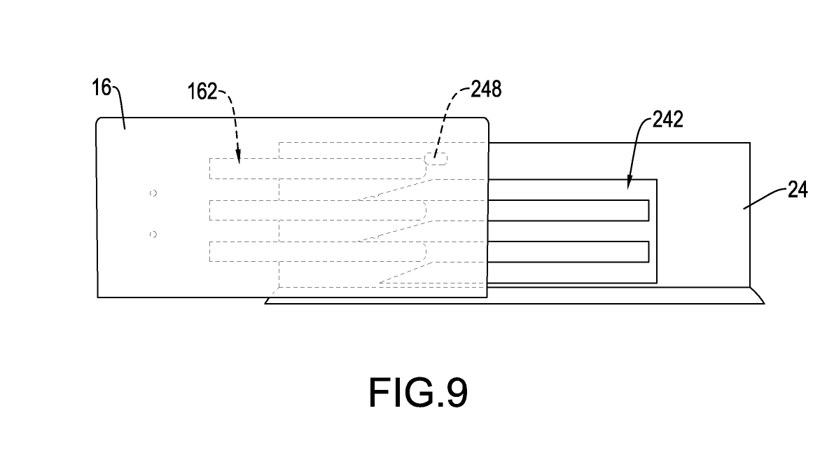

To connect the filter 20 with the filter head 10, the top end of the filter body 22 is inserted into the filter head 10 from the opened bottom end of the outer casing 12 and into the filter connector 14. When the top end of the filter body 22 enters into the filter connector 14, the key block 242 on the keyed collar 24 will align with the key blocks 162 on the keyed tabs 16. With the correspondence of form, shape and arrangement between the key blocks 162,242 on the keyed tabs 16 and the keyed collar 24 as shown in FIG. 8, the filter 20 can be rotate relative to the filter head 10 to communicate the water flow passage in the filter body 22 with the water flow passage in the filter connector 14. If the form, shape and arrangement of the key block 242 on the keyed collar 24 do not correspond to the key blocks 162 on the keyed tabs 16 as shown in FIG. 9, the filter body 22 cannot be rotated relative to the filter connector 14, and the filter 20 cannot be combined with the filter head 10. Accordingly, only a filter 22 provided with a keyed collar 24 having a specific key block 242 can be assembled with the filter head 10 that has key blocks 162 with specific form, shape and arrangement to enable the water filter assembly to achieve a specific filtering purpose. Thus, a fool-proofing effect is provided.

In addition, the keyed collar 24 may further have an identifying block 248 formed on the keyed collar 24 and spaced from the key block 242. A distance is defined between the identifying block 248 and the key block 242 and is various by changing the position of the identify block 24. Thus, when the distance between the identifying block 248 and the key block 242 corresponds to the key blocks 162 on the keyed tabs 16 as shown in FIG. 8, the filter 20 can be connected to the filter head 10. When the distance between the identifying block 248 and the key block 242 does not correspond to the key blocks 162 on the keyed tabs 16 as shown in FIG. 9, the filter 20 cannot be connected to the filter head 10 as. Accordingly, a fool-proofing effect can also be provided. Alternatively, the identifying block may be formed on each keyed tab 16.

Additionally, a positioning device is mounted between the key blocks 162,242 on the keyed tabs 16 and the keyed collar 24 to prevent the filter 20 from being rotated unintentionally. Preferably, the positioning device may comprise multiple positioning rods and positioning recesses formed respectively on the keyed tabs 16 and the key block 242 on the keyed collar 24.

Furthermore, because the key blocks 162,242 are formed on the keyed tabs 16 and the keyed collar 24, multiple filter heads 10 that have key blocks 162 in different forms, shapes and arrangements and multiple filters 20 that have key blocks 242 in corresponding forms, shapes and arrangements can be easily manufactured to fit with each other. A mold for forming an entire filter head or filter body provided with an integral key block is unnecessary during the injection molding process. Therefore, the water filter assembly in accordance with the present invention is versatile in use and can be manufactured in reduced costs.

In addition, because the keyed collar 24 and the filter body 22 are separate elements, the keyed collar 24 and the filter body 22 can be made of different materials. For example, the keyed collar 24 can be made of metal, such as cast iron, copper, lead, aluminum alloy or aluminum magnesium alloy, such that the keyed collar 24 can provide a sufficient structural strength to combine the filter 20 with the filter head 10 and is not easily deformed. The filter body 22 can be made of plastic material, such as Polyphenylene Sulfide (PPS), Polysulfone (PSU), Polyether Sulfone (PES), Polyether Ether Ketone (PEEK), Aromatic Polyesters Resin Liquid Crystal Polymer (LCP), Polyether Imide (PEI), Polyacetal Homopolymer Copolymer (POM), Polyamide Nylon 6, Nylon 66, Nylon 12 or Nylon 46 (PA), Polycarbonate (PC), Polyethylene terephthalate (PET), Acrylonitrile Butadine Styrene (ABS), Acrylonitrile Styrene Acrylate (ABA), Polystyene (PS), Cellulose Acetate (CA), Thermoplastic Polyurethane (PTU), Styrene-Acrylonitrile (SAN(AS)), Thermoplastic Styrene Elastomer (TPS), Polytetra fluoroethylene (PTEE), Polypropylene (PP), Polyethylene (PE) or Polyamide Nylon (PA). Accordingly, the filter body 22 may have capabilities of strike-resistance, resilience, compress-resistance and chemical-resistance to fit with different needs.

Additionally, the keyed collar 24 and the keyed tabs 16 can be easily formed with injection molding process, and the forms, shapes and arrangements of key blocks 162,242 on the keyed tabs 16 and the keyed collar 24 are not limited by the molds of the injection molding process.

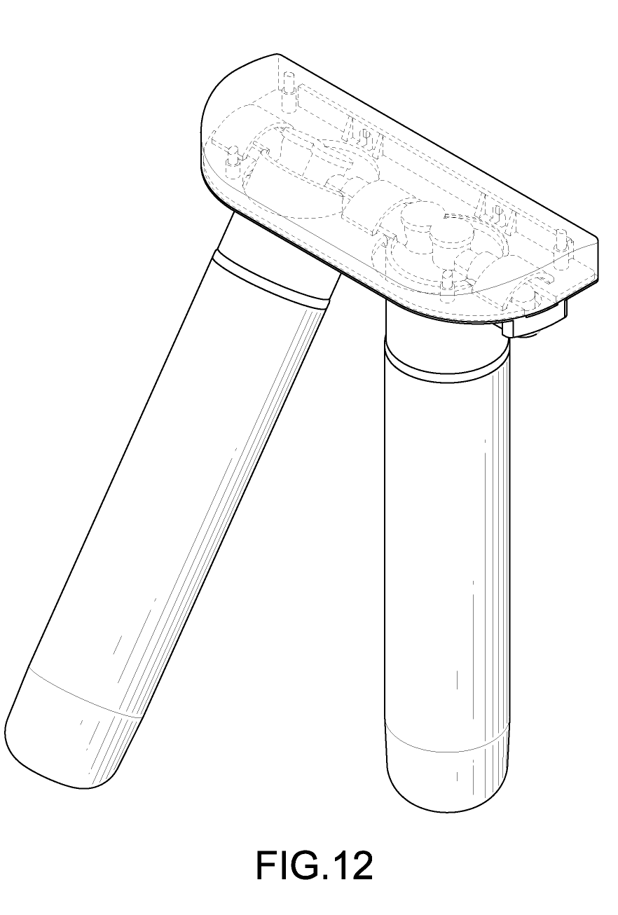

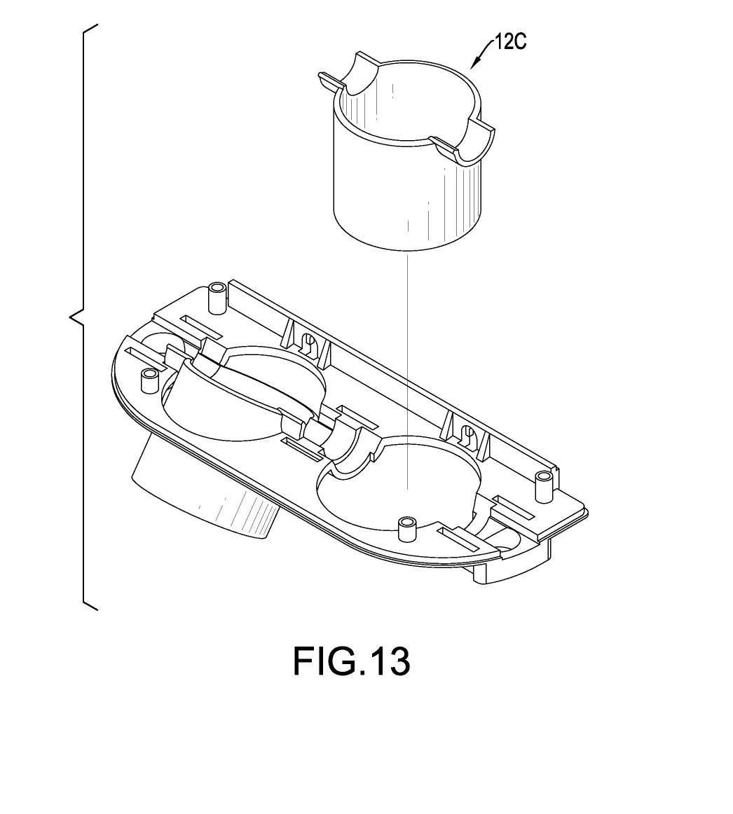

With reference to FIGS. 12 and 13, the water filer assembly can be attached to a manifold bracket to form as manifold system. In the operational embodiment shown in FIGS. 12, two water filter assemblies are mounted on a manifold bracket. The outer casing 12C of the water filter assembly has two pivotal ears formed on and protruding laterally from the top end of the outer casing. Each pivotal ear has a curved cross section. Accordingly, the water filter assemblies are pivotable relative to the manifold bracket.

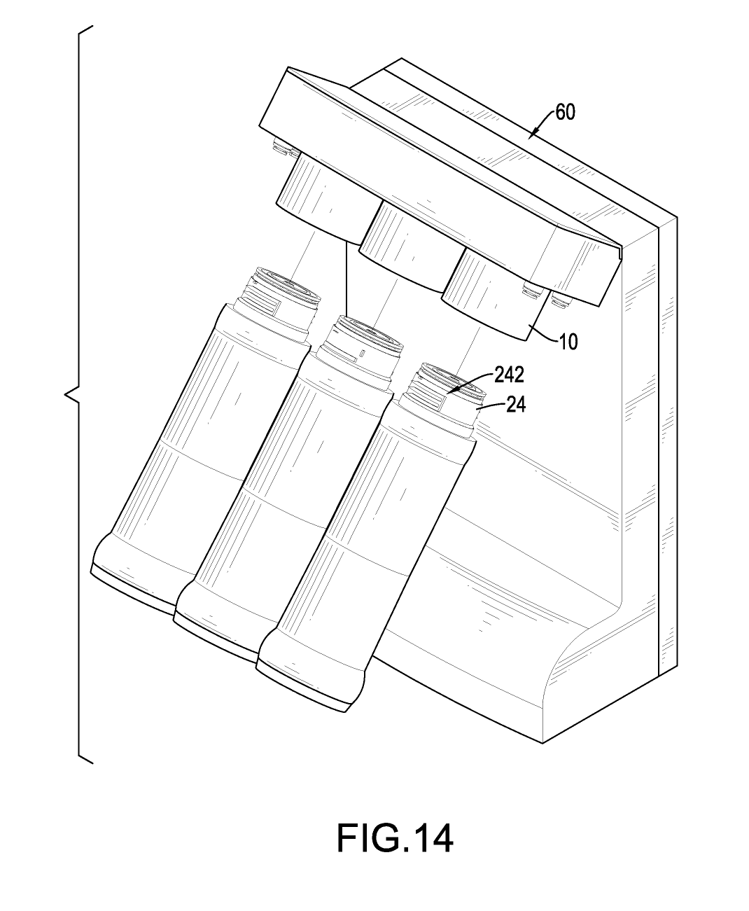

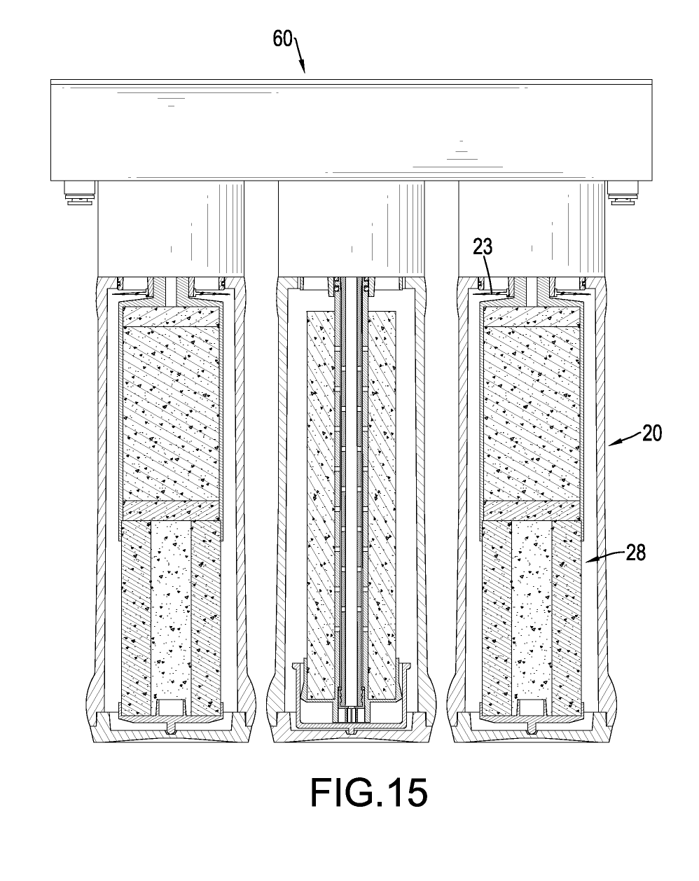

With reference to FIGS. 14 and 15, three water filter assemblies are mounted on a manifold bracket 60. Each water filter assembly has a filter cartridge 28 different that of the other water filter assembly to provide different filtering effects. In addition, the key block 242 on the keyed collar 24 of each water filter assembly is also different that on the other water filter assembly. Therefore, a specific filter 20 can only be connected with a specific filter head 10 mounted on the manifold bracket 60 to provide a fool-proofing effect.

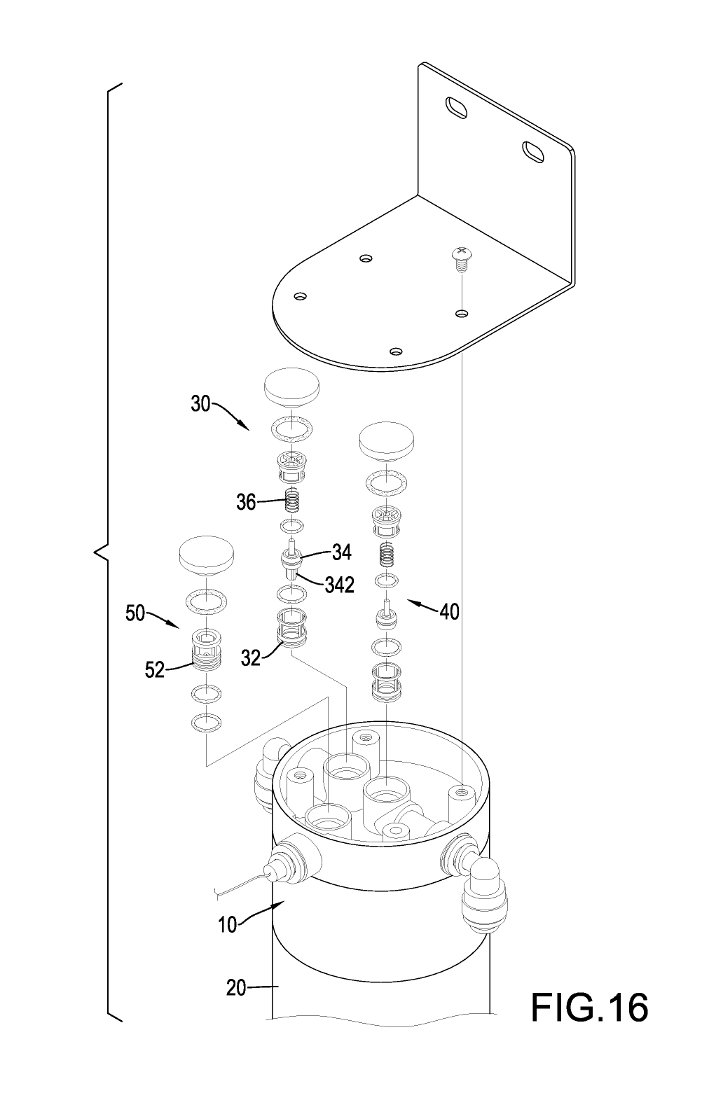

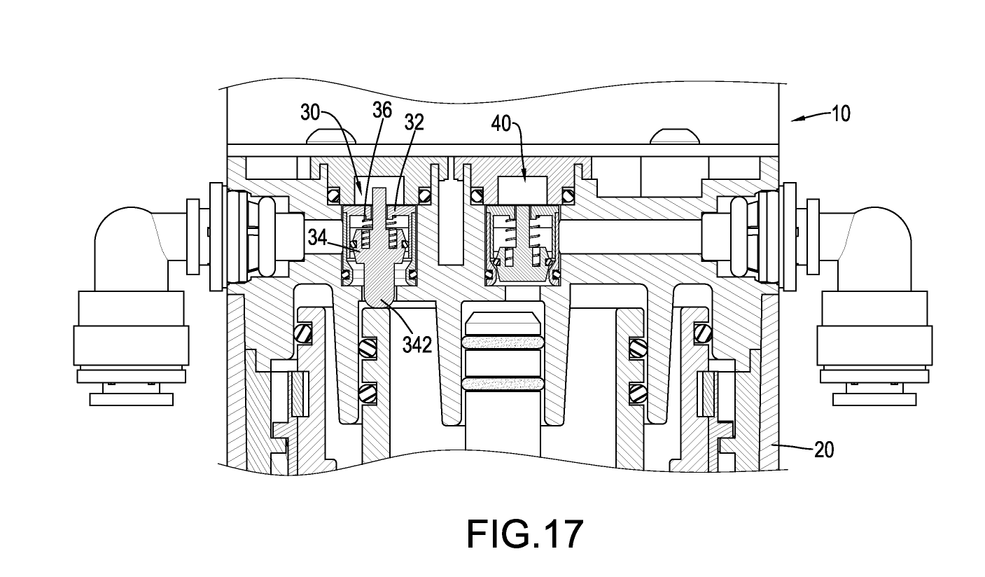

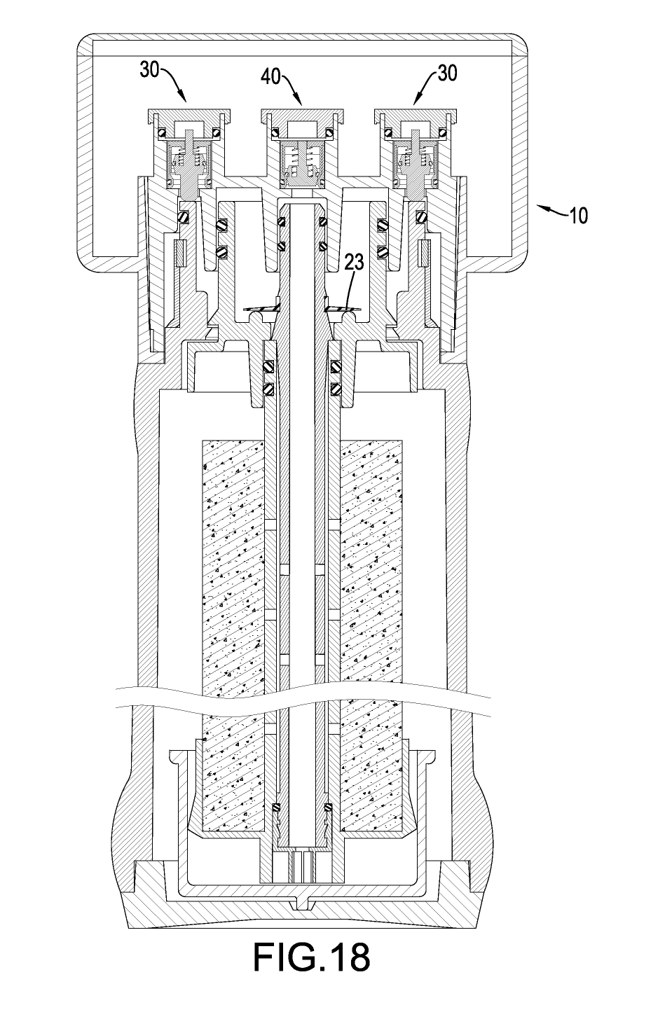

With reference to FIGS. 16 and 17, a turn off switch 30, a check valve 40 and a flow control valve 50 are mounted in the filter head 10. The turn off switch 30 comprises a housing 32, a valve disk 34 and a spring 36. The valve disk 34 is moveably mounted in the housing 32 and has a pushed rod 342 extending out of the housing 32. The spring 36 is mounted in the housing 32 and abuts with the valve disk 34. With the force provided by the spring 36, the valve disk 34 closes the flow passage of the turn off switch 30. When a filter 20 is attached to the filter head 20, the filter 20 will push the pushed rod 342 to move the valve disk 34 relative to the housing 10 and to open the flow passage of the turn off switch 30. Accordingly, water can flow into the filter 20 via the turn off switch 30 in the filter head 10. When the filter 20 is detached from the filter head 10, the spring 36 will push the valve disk 34 to move and to close the flow passage in the turn off switch 30. Thus, water in the filter head 10 can be prevented from leaking during the replacement of the filter 20. The check valve 40 has a structure similar to that of the turn off switch 30 but does not have a pushed rod 342. With the arrangement of the check valve 40, the water flow direction in the water filter assembly can be controlled. The flow control valve 50 has a housing 52 and a controlling disk. The controlling disk is mounted in the housing 52 and has a flow passage defined through the controlling disk. With a various diameter of the flow passage in the controlling disk, the water flow passing through the controlling disk can be changed and controlled.

With reference to FIG. 18, in an alternative embodiment, two turn off switches 30 and a check valve 40 are mounted in the filter head 10 to be applied for different flow control purpose.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A quick change keyed water filter assembly comprising:
a filter head comprising:
an outer casing having
an inner surface; and
two securing recesses defined in the inner surface of the outer casing;
a tubular filter connector mounted in the outer casing and having
an outer surface; and
two tab holes defined through the outer surface of the filter connector and aligning respectively with the securing recesses in the outer casing;
two keyed tabs mounted respectively in the tab holes in the connecting bracket and each having an inner surface and a key block formed on the inner surface of the keyed tab; and
two tab fasteners mounted respectively in and protruding partially out of the tab holes and extending respectively into the securing recesses to securely hold the filter connector in the outer casing; and
a filter connected detachably with the filter head and comprising:
a filter body having
a top end extending detachably into the filter connector; and
an annular combining recess defined around the filter body at a position near the top end;
a keyed collar mounted around the top end of the filter body, detachably engaging the keyed tabs and having
an inner surface;
an outer surface; and
a key block formed on the outer surface of the keyed collar and detachably engaging the key blocks on the keyed tabs; and
a collar fastener mounted in and protruding partially out of the combining recess and abutting the inner surface of the keyed collar to securely hold the keyed collar on the filter body.

2. The quick change keyed water filter assembly as claimed in claim 1, wherein the collar fastener is C-shaped and has a curvature different from that of the combining recess.

3. The quick change keyed water filter assembly as claimed in claim 2, wherein the filter body is made of a material different from that of the keyed collar.

4. The quick change keyed water filter assembly as claimed in claim 3, wherein the securing recesses are defined respectively in two ends of a diameter of the outer casing.

5. The quick change keyed water filter assembly as claimed in claim 4, wherein the keyed collar has an enlarged hole defined in an end of the keyed collar to form an annular abutting shoulder inside the keyed collar and abutting the collar fastener.

6. The quick change keyed water filter assembly as claimed in claim 5, wherein a key and a keyway are respectively formed on the filter body and the inner surface of the keyed collar and engage each other.

7. The quick change keyed water filter assembly as claimed in claim 6, wherein at least one positioning rib and at least one positioning recess are respectively formed on the inner surface of the outer casing and the filter connector and engage each other respectively.

8. The quick change keyed water filter assembly as claimed in claim 7, the keyed collar further has an identifying block formed on the keyed collar and spaced from the key block.

9. The quick change keyed water filter assembly as claimed in claim 8, a positioning device is mounted between the key blocks on the keyed tabs and the keyed collar to prevent the filter from being rotated unintentionally.

10. The quick change keyed water filter assembly as claimed in claim 9, the filter head has turn off switch mounted in the filter head.

11. The quick change keyed water filter assembly as claimed in claim 1, wherein the filter body is made of a material different from that of the keyed collar.

12. The quick change keyed water filter assembly as claimed in claim 1, wherein the securing recesses are defined respectively in two ends of a diameter of the outer casing.

13. The quick change keyed water filter assembly as claimed in claim 1, wherein the keyed collar has an enlarged hole defined in an end of the keyed collar to form an annular abutting shoulder inside the keyed collar and abutting the collar fastener.

14. The quick change keyed water filter assembly as claimed in claim 1, wherein a key and a keyway are respectively formed on the filter body and the inner surface of the keyed collar and engage each other.

15. The quick change keyed water filter assembly as claimed in claim 1, wherein at least one positioning rib and at least one positioning recess are respectively formed on the inner surface of the outer casing and the filter connector and engage each other respectively.

16. The quick change keyed water filter assembly as claimed in claim 1, the filter head has turn off switch mounted in the filter head.

17. The quick change keyed water filter assembly as claimed in claim 1, the keyed collar further has an identifying block formed on the keyed collar and spaced from the key block.

18. The quick change keyed water filter assembly as claimed in claim 1, a positioning device is mounted between the key blocks on the keyed tabs and the keyed collar to prevent the filter from being rotated unintentionally.
